(19) United States
(12) Patent Application Publication
(10) Pub. No.: US 2010/0074584 A1
(43) Pub. Date: Mar. 25, 2010

(54) ELECTRO-OPTIC DEVICE AND METHOD FOR MAKING LOW RESISTIVITY HYBRID POLYMER CLADS FOR AN ELECTRO-OPTIC DEVICE

(75) Inventors: Danliang Jin, Bothell, WA (US); Guomin Yu, Bothell, WA (US); Anna Barklund, Kirkland, WA (US); Hui Chen, Kirkland, WA (US); Raluca Dinu, Redmond, WA (US)

Correspondence Address: GRAYBEAL JACKSON LLP, 400 - 108TH AVENUE NE, SUITE 700, BELLEVUE, WA, 98004, US

(73) Assignee: GIGOPTIX, INC., Bothell, WA (US)

(21) Appl. No.: 12/559,727

(22) Filed: Sep. 15, 2009

Related U.S. Application Data
(60) Provisional application No. 61/097,172, filed on Sep. 15, 2008.
(60) Provisional application No. 61/097,166, filed on Sep. 15, 2008.

(51) Int. Cl. G02B 6/02; G02B 6/10; B05D 1/04; C08F 2/48

(52) U.S. Cl. 385/123; 385/131; 427/458; 427/508

(57) ABSTRACT

A low resistivity hybrid optical cladding may be formed from a sol-gel doped with an inorganic salt such as lithium perchlorate. An electro-optic device may be formed by poling an organic chromophore-loaded modulation layer through at least one layer of the low resistivity hybrid optical cladding.

### CROSS-REFERENCE TO RELATED APPLICATIONS

This application claims priority benefit under 35 U.S.C. §119(e) from, and to the extent not inconsistent with this application, incorporates by reference herein U.S. Provisional Patent Application Ser. No. 61/097,172; filed Sep. 15, 2008; entitled “ELECTRO-OPTIC DEVICE AND METHOD FOR MAKING LOW RESISTIVITY HYBRID POLYMER CLADS FOR AN ELECTRO-OPTIC DEVICE”; invented by Danliang Jin, Guomin Yu, Anna Barklund, Hui Chen, and Raluca Dinu.

This application is related to U.S. Provisional Patent Application Ser. No. 61/097,166 (attorney docket number 2652-044-02); filed Sep. 15, 2008; entitled “LOW REFRACTIVE INDEX HYBRID OPTICAL CLADDING AND ELECTRO-OPTIC DEVICES MADE THEREFROM”, invented by Danliang Jin, Guomin Yu, and Hui Chen, and to the extent not inconsistent

### STATEMENT REGARDING FEDERALLY SPONSORED RESEARCH OR DEVELOPMENT

The inventions disclosed herein were made the U.S. Government support pursuant to NRO Contract No. NRO000-07-C-0123 and DARPA Contract No. W31P4Q-08-C-0198. Accordingly, the Government may have certain rights in the inventions disclosed herein.

### BACKGROUND

Electro-optic devices, and especially poled hyperpolarizable organic chromophore-based electro-optic devices have typically been limited to using cladding materials that are either characterized by relatively high resistivity or by large optical losses.

### SUMMARY

According to an embodiment, a low resistivity hybrid organic-inorganic optical cladding may be prepared by mixing a sol-gel solution and an inorganic salt dopant, gelling the mixture to produce a hybrid polymer with inorganic salt dopant, and drying and curing the gel to form a film.

According to embodiments, an electro-optic device such as an electro-optic modulator includes at least one low resistivity inorganic salt doped hybrid organic-inorganic optical cladding. According to embodiments a sol-gel optical cladding is doped with 1% to 3% lithium perchlorate.

### BRIEF DESCRIPTION OF THE FIGURES

FIG. 1 is a cross-sectional diagram of an electro-optic device, according to an embodiment.

FIG. 2 is a simplified diagram of system including an electro-optic device of FIG. 1, according to an embodiment.

FIG. 3 is a hypothetical diagram of a poling voltage distribution during poling of the device 101 of FIGS. 1 and 2, according to an embodiment, in comparison with a hypothetical prior art device.

FIG. 4 is a hypothetical representation of a poled electro-optic core showing relatively poor alignment (poling) of chromophores.

FIG. 5 is a hypothetical representation of a poled electro-optic core showing relatively good alignment (poling) of chromophores resulting from poling according to an embodiment.

FIG. 6 is a flow chart showing a method for making a doped hybrid organic-inorganic optical cladding according to an embodiment.

FIG. 7 is a graph showing an effect of resistivity on a doped vs. un-doped hybrid organic-inorganic optical cladding, according to an embodiment.

FIG. 8 is a graph showing a comparison of leak-through current between an extrapolation of a doped hybrid organic-inorganic doped cladding material made according to an embodiment, and a conventional UV-cured optical cladding material.

FIG. 9 is a cross-sectional diagram of an alternative device structure, according to an embodiment.

FIG. 10 is a cross-sectional diagram of another alternative device structure, according to an embodiment.

FIG. 11 is a diagram illustrating several steps of fabrication of a device, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

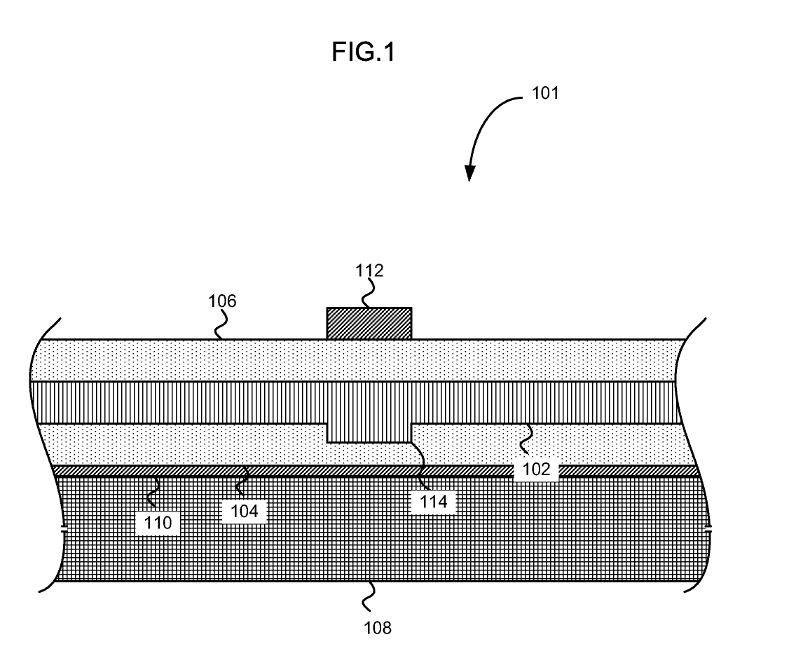

FIG. 1 is a cross-sectional diagram of an electro-optic device 101, according to an embodiment. The electro-optic device 101 includes an electro-optic core 102 disposed between optical clads 104 and 106. The electro-optic device 101 may be formed over a substrate 108 such as silicon, silicon-on-insulator, glass, or other semiconducting or insulating wafer. Two electrodes 110, 112 are arranged to apply a modulation voltage across the electro-optic core 102 through the clads 104, 106. One or more light guiding structures 114, such as a trench waveguide, etc. may be provided to guide light transmitted through the electro-optic core 102 for modulation.

The electro-optic core may include at least one type of hyperpolarizable organic chromophore and cross-linked polymer. The at least one hyperpolarizable organic chromophore and the polymer may form a guest-host material. Alternatively, the hyperpolarizable organic chromophore may be covalently bonded to the cross-linked polymer, or may be otherwise held in the cross-linked polymer. The cross-linked polymer may include an organic polymer, such as amorphous polycarbonate for example, or may include a hybrid material such as a sol-gel.

Typically, the electro-optic core material is poled, ideally to substantially align the chromophores. The core may be poled by applying a poling voltage from a poling electrode (not shown in FIG. 1) across the electro-optic core 102 through some or all of the cladding 106, 104 thickness while the device 101 is heated to near a glass transition temperature, Tg, of the polymer in the core. After the chromophores are aligned, the device 101 is cooled to “lock” the chromophores into their poled orientations. The poling electrode 116 may include a temporary electrode that is removed after poling. Alternatively, a modulation electrode 112 may be used as a poling electrode 116.

According to embodiments, the electrical resistivity of the material in at least one of the optical clads 104, 106 is about an order of magnitude lower than the resistivity of the material in the electro-optic core 102 at room temperature and higher. According to embodiments, the electrical resistivity of at least one of the optical cladding layers 104, 106 is at least about two orders of magnitude lower than the resistivity of the electro-optic core material at poling temperatures. The reduced electrical resistivity of the optical cladding layers 104, 106 may be leveraged to reduce poling voltage and/or increase poling efficiency. Increased poling efficiency, in turn, may be used to decrease modulation voltage, decrease device length, and/or provide deeper light modulation.

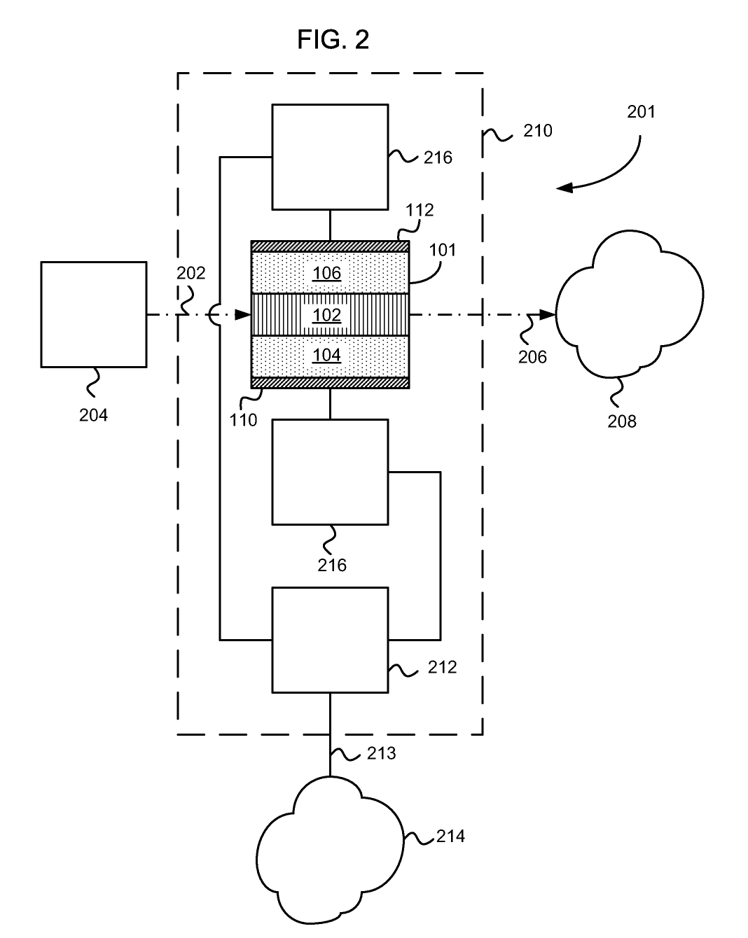

FIG. 2 is a simplified diagram of system 201 including an electro-optic device 101, according to an embodiment. In operation, light 202 such as laser light from a laser 204 at an infrared wavelength may be passed through the electro-optic core 102. To provide light guidance and minimize optical losses, the optical clads 104, 106 typically have indices of refraction that are lower than the index of refraction of the electro-optic core 102. For example, according to an embodiment, the nominal index of refraction of the electro-optic core 102 may be about 1.5 to 1.7 and the index of refraction of the clads 104, 106 may be about 1.45 to 1.47.

During operation, one electrode 110 may be held at ground while the other electrode 112 is voltage modulated. In some applications, the electrode 112 may be a top electrode that is provided in the form of a high speed strip electrode configured to propagate modulation pulses along its length, parallel to and preferably at least somewhat velocity-matched to the propagation of light through the electro-optic core 102. The poled hyperpolarizable chromophore in the electro-optic core 102 responds to the modulation voltage with a corresponding change in refractive index, which operates to modulate the phase of the propagated light 202. A device may be used to provide a phase-modulated light signal 206 for transmission through a network 208. Alternatively, a device, such as in a Mach-Zehnder modulator, may include plural optical channels, each modulating a portion of coherent light, which, when the light is rejoined, may destructively or constructively interfere to provide an amplitude-modulated light signal 206 for transmission.

According to embodiments, the electro-optic device 101 may be combined with other components in an integrated device 210. Such components may include a receiving circuit 212 configured to receive one or more signals along an input signal transmission path 213 from a network 214 or other signal source, and drive electronics 216 configured to provide the drive signal to the electrodes 110, 112.

It may be desirable to minimize the propagation path length L along the electro-optic core 102. For example, shorter cores may provide lower propagation loss and/or reduce device real estate, and hence cost. It may also be desirable to minimize drive voltage applied to the electrodes 110, 112. For example, lower drive voltage may be easier to produce at very high frequencies typical of optical data transmission, and lower drive voltage may lend itself to higher levels of device integration.

Because of the relatively high poling efficiency and/or the relatively low resistivity of the clads 104, 106, the modulation voltage may be decreased. For example the electrodes 110, 112 may be configured to provide an electrical drive pulse of about 0.9 to 1.1 volts through the clad 104, electro-optic core 102, and top clad 106. Moreover, the bottom clad 104, electro-optic core 102, and top clad 106 may be configured, through geometry and/or relative resistivity, to deliver more than about 50% of the drive voltage across the electro-optic core 102. According to some embodiments, the bottom clad 104, electro-optic core 102, and top clad 106 may be configured to deliver more than about 90% of the drive voltage across the electro-optic core 102.

Referring again to FIG. 1, the low resistivity claddings 104, 106 may lend themselves to lower drive voltage, because relatively less of the voltage difference between the electrodes 110, 112 may be incurred in the claddings 104, 106, leaving a larger signal available to drive the electro-optic core 102. Also, low resistivity claddings 104, 106 may allow more favorable poling conditions and results.

According to embodiments, the bottom clad 104 may be about 1-2 microns thick below the waveguide 114 and/or about 2-2.4 microns thick without the trench waveguide 114 or at locations not corresponding to a trench waveguide 114. The electro-optic core 102 may be about 3 microns thick including a trench waveguide 114 and/or about 2 microns thick without the trench waveguide 114 or at locations not corresponding to the trench waveguide 114. The top clad may be about 0.5 to 2.0 microns thick.

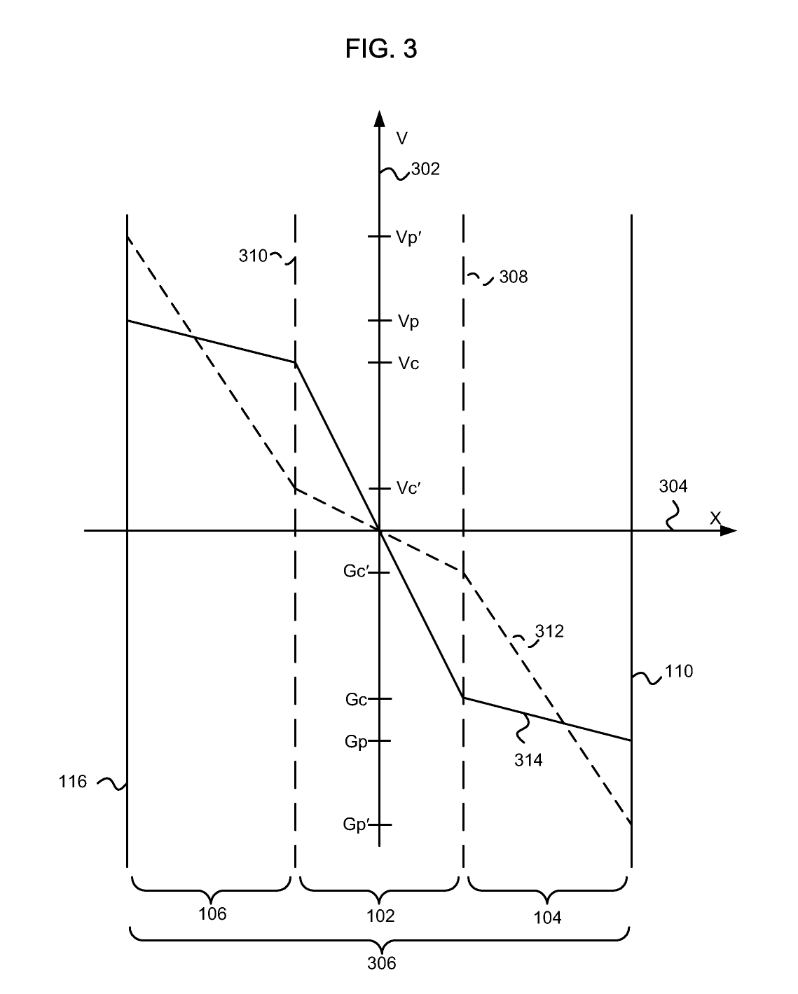

FIG. 3 is a hypothetical diagram of a poling voltage distribution 301 during poling of the device 101 of FIGS. 1 and 2, in comparison with a hypothetical prior art device according to an embodiment. A vertical axis 302 represents voltage V and the horizontal axis 304 represents distance X through the cross-section 306 of the electro-optic device. For simplicity, the cross-section 306 is shown as three equal-width sections respectively corresponding to the upper clad 106, electro-optic core 102, and lower clad 104 shown in the device 101 of FIG. 1. A vertical line 308 represents an interface between the electro-optic core 102 and the clad 104, and a vertical line 310 represents an interface between the electro-optic core 102 and the clad 106. Vertical line 110 represents a ground electrode and vertical line 116 represents a poling electrode. A hypothetical voltage curve 312 represents a poling voltage distribution according to a prior art device having relatively high resistivity clads 104, 106. A hypothetical voltage curve 314 represents a poling voltage distribution according to an embodiment of the invention.

According to the prior art, a poling voltage Vp′ is applied to electrode 116 while the other electrode 110 is held at ground Gp′. From inspection of the curve 312, it may be seen that a relatively large amount of the difference between Vp′ and Gp′ is attributable to voltage drop across the cladding layers 104, 106. This leaves a relatively small voltage difference across the core, Vc′−Gc′ available for poling the chromophore contained within the core.

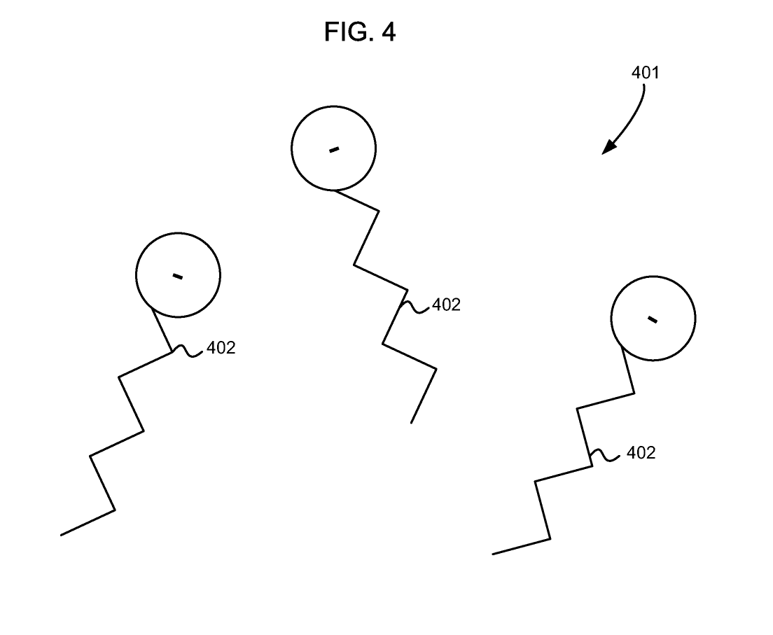

FIG. 4 is a hypothetical representation of a poled electro-optic core 401 showing relatively poor alignment (poling) of chromophores 402 resulting from poling according to the prior art. The alignment of the chromophores 402, while generally parallel, are not extremely parallel because the relatively small voltage difference across the core, Vc′−Gc′, does not provide sufficient poling driving force to overcome viscosity and resistance to rotation of the chromophores 402 during poling to produce complete parallelism between the poled chromophores 402.

Referring again to FIG. 3, voltage curve 314 represents a poling voltage according to an embodiment of the invention. A poling voltage Vp is applied to electrode 112 while the other electrode 110 is held at ground Gp. From inspection of the curve 314, it may be seen that a relatively small amount of the difference between Vp and Gp is attributable to voltage drop across the cladding layers 104, 106. This leaves a relatively large voltage difference across the core, Vc−Gc available for poling the chromophore contained within the core.

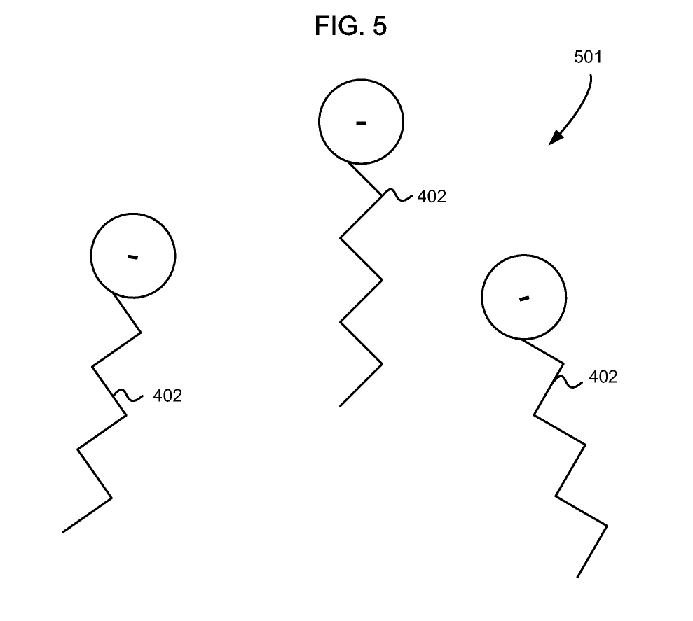

FIG. 5 is a hypothetical representation of a poled electro-optic core 501 showing relatively good alignment (poling) of chromophores 402 resulting from poling according to an embodiment. The alignment of the chromophores 402, is quite parallel because the relatively large voltage difference across the core 102, Vc−Gc, provides improved poling driving force to overcome viscosity and resistance to rotation of the chromophores 402 during poling. This produces better parallelism between the poled chromophores 402. The degree to which the chromophores are poled may be referred to as the poling efficiency. Poling efficiency may be reflected in units picometers per volt. Higher poling efficiencies may allow reduced modulation voltage, reduced device size, or both.

Referring again to FIG. 3, the poling voltage Vp may be reduced through use of the low resistivity clads 104, 106. According to an embodiment, a reduced poling voltage of about 500 volts may be used, compared to a typical prior art poling voltage of about 900 volts or more. Additionally, the poling efficiency of the device 101 may be increased. Higher poling efficiencies may allow lower modulation voltage to produce a desired modulation depth, may allow the use of a shorter electro-optic core, and/or may reduce voltage stress placed on the part during poling and/or operation.

Referring again to FIG. 1, the low resistivity material in the cladding layers 104, 106 includes a hybrid organic-inorganic material. The hybrid organic-inorganic material may be referred to as a sol-gel material. The chemical structure of the sol-gel may be expressed as:

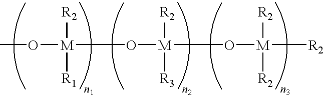

R₁=-alkyl or aromatic groups
R₂═H, alkoxy groups, such as —O—CH₃, —O—(CH₂)ₙCH₃
R₃=crosslinkable groups such as

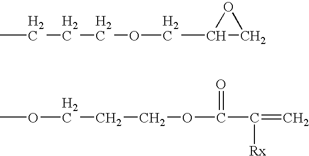

M=Si, Ti, Al, Zr, . . .

For example, according to an embodiment, the sol-gel may include:

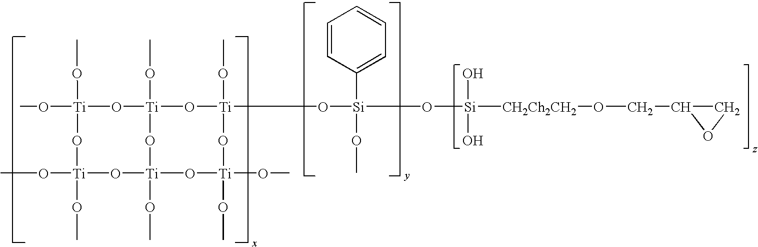

To reduce the electrical resistivity, the hybrid organic-inorganic cladding material may be doped with an inorganic or organic salt. The concentration of the salt may be at a concentration equal to or less than about 5%, for example. According to an embodiment, the cladding is doped with an inorganic salt of lithium, sodium, or potassium at a concentration equal to or less than about 2%. According to an embodiment, the cladding is doped with lithium perchlorate at a concentration of between about 1% and 3%. According to an embodiment, the cladding is doped with lithium perchlorate at a concentration of about 2%.

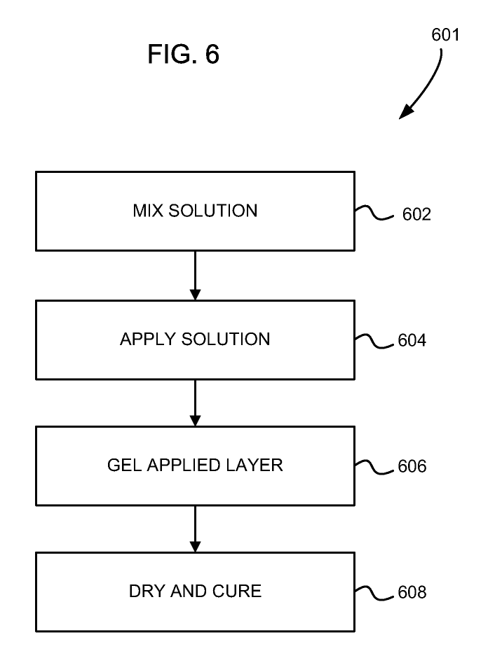

FIG. 6 is a flow chart showing a method 601 for making a hybrid organic-inorganic optical cladding according to an embodiment. In step 602, a sol-gel solution and inorganic salt dopant are mixed. Specific embodiments may be made by reference to the following examples:

### Example 1

### Polymer 1

An organically modified titania-siloxane sol-gel was prepared by: 1) dripping 127.2 g of titanium butoxide (from Aldrich, double distilled) into a solution of 592 g of anhydrous ethanol and 24.0 g of concentrated HCl (about 37 wt %); 2) dripping 94.3 g of H2O; 3) dripping 99.2 g of glycidoxypropyltrimethoxysilane; 4) heating at about 80° C. for 12 hours; 5) dripping 372.0 g of phenyltriethoxysilane (from Aldrich, distilled) while at about 80° C. for 4 hours; and 6) adding distilled 473 g of cyclohexanone into the solution and stir to homogeneity. 3.0 gram of Lithium perchlorate is added and stirred until complete dissolved. The low boiling volatiles from the reaction were removed by rotary evaporation.

### Example 2

### Polymer 2

An organically modified sol-gel was prepared by 1) adding 17.83 g methyltriethoxysilane (from Aldrich, double distilled), 70.80 g glycidoxypropyl-trimethoxysilane (from Aldrich, double distilled), 64.2 g cyclohexanone (from Aldrich, distilled) to a flask; 2) dripping a solution of 21.78 g H2O and 2.050 g 2M HCl; and 3) heating at 80 to 100° C. for 5 hours. 0.567 gram of lithium perchlorate is added after all above procedure.

Proceeding to step 604, the solution is applied to a surface. For example, the solution may be spin-coated or sprayed onto a substrate such as a silicon, glass, or silicon-on-insulator wafer. The substrate may include one or a plurality of bottom electrodes (FIG. 1, 110).

Next, in step 606, the applied layer is cured thermally or via an ultraviolet and thermal process. A backbone molecular structure for the cured material. A general material structure is illustrated below before doping any salts.

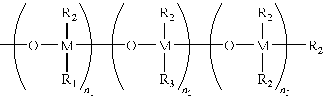

R₁=-alkyl or aromatic groups
R₂═H, alkoxy groups, such as —O—CH₃, —O—(CH₂)ₙCH₃
R₃=crosslinkable groups such as

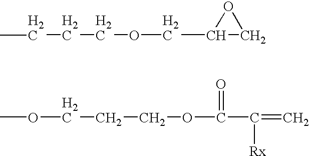

M=Si, Ti, Al, Zr, . . .
   The inorganic polymeric backbone includes Si, Ti, Zr, Al, etc.

There are two types of gelling or crosslinking mechanisms. One is from the inorganic backbone and the other is from the organic components. Detailed crosslinking mechanisms may be seen in U.S. Pat. No. 7,206,490, incorporated by reference herein.

An example of a structure that relates to the synthetic procedures described in example form above is given below. Generally y is greater than x. According to an embodiment, y may be about three times x:

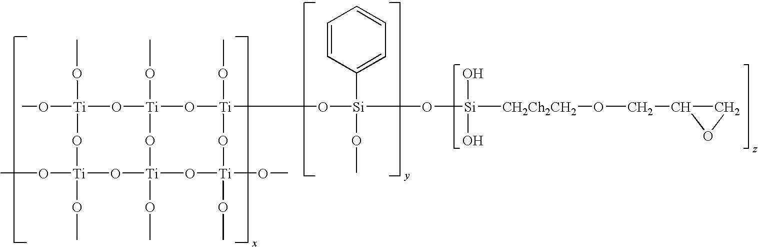

Proceeding to step 608, the gelled material is further condensed and cured to form a solid film, which in turn forms the optical cladding.

After gelling, drying, and curing, the inorganic salt may be molecularly dispersed. Molecular dispersion may reduce the propensity of the salt to scatter light and reduces optical losses through the device. Compared to prior art, for example systems using a UV-cured polymer with a dopant present at 10% to 20% or even higher concentrations, the low concentration taught herein in combination with the high solubility in the hybrid material reduces agglomeration and/or crystallization of the salt and thus reduces or eliminates the occurrence of large particles and/or other phase separation that may cause optical loss.

The dopant molecules may be sealed by the highly crosslinked hybrid networks. Such sealing may prevent the aggregation and serve as barrier to moisture. The inorganic salt dopant may be present at a range of concentrations. The electrical resistivity depends on the doping level.

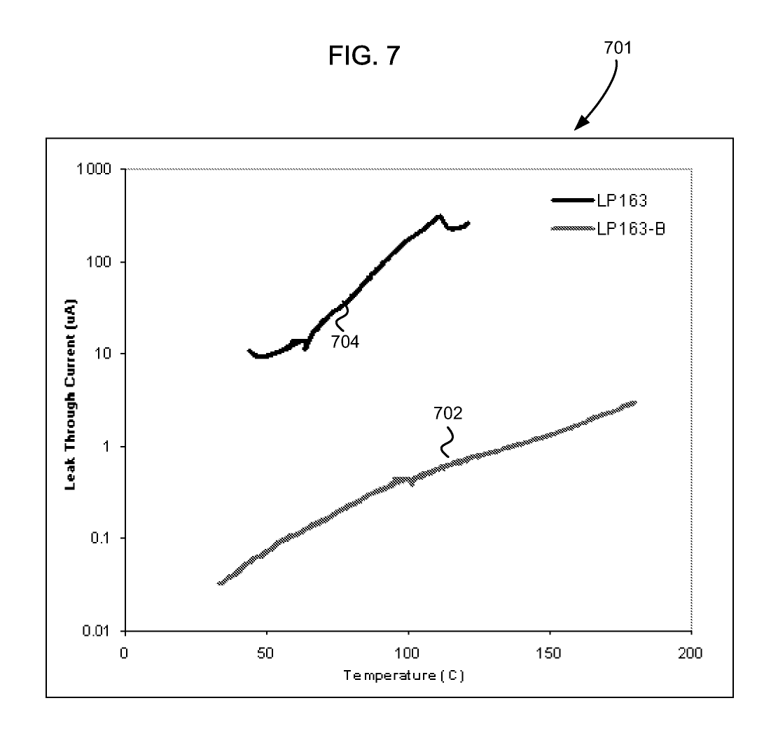

FIG. 7 is a graph 701 showing an effect of resistivity on a doped vs. un-doped hybrid organic-inorganic optical cladding material at 10 volts per micron, according to an embodiment. LP163-B is an un-doped hybrid organic-inorganic optical cladding material represented by curve 702. LP163, represented by curve 704, is doped at 1% by weight lithium perchlorate. In the example of FIG. 7, 1 wt-% of LiClO4 can reduce the resistance of the hybrid materials up to 3 orders of magnitude at 120° C. At higher than 120° C., the leak through current of one example of doped organic-inorganic hybrid is so high that causes the film breakdown. In comparison, an un-doped sample of the same organic-inorganic hybrid can run up to 180° C. without breaking down, due to a relative low leak through current corresponding to a higher resistance.

Compared to organic salt doped UV curable resin, the reduction of resistance, according to embodiments, is much more significant. Thus, relatively lower dose is required for a given resistivity reduction. Such a low dose may reduce the effect on other material properties such as optical transmissivity and absorption, as well as mechanical properties. If needed, the dopant loading may be adjusted to meet a resistivity goal.

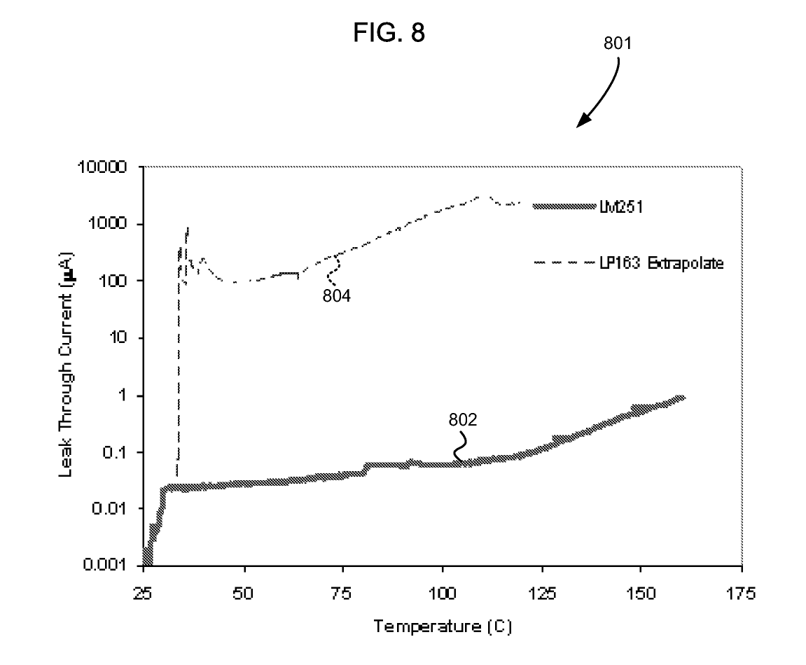

FIG. 8 is a graph 801 showing a comparison of leak-through current under 100 volts per micron between a conventional UV-cured optical cladding material against an extrapolation of a hybrid organic-inorganic doped cladding material, according to an embodiment. LM251, represented by curve 802, is a normal UV cured resin with methacrylate backbone structure. Its leak-through current is fairly low even at 100 volts per micron. In order to have a parallel comparison, the leak-through current of LP163, represented as curve 804, is extrapolated to 100 volts per micron electrical fields, though it would burn immediately due to the high current. One can see that the leak-through current of LP163 is at least 4 orders of magnitude higher than LM251.

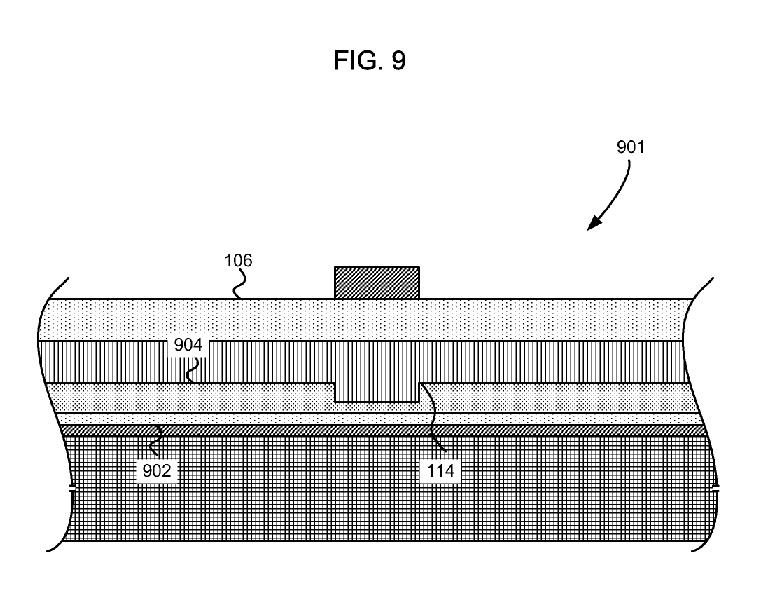

FIG. 9 is a cross-sectional diagram of an alternative device structure 901, according to an embodiment. In some embodiments, it may be advantageous to combine the low resistivity hybrid organic-inorganic cladding layers with one or more other cladding layers formed from more conventional materials. For example, a bottom cladding layer may include a first cladding layer 902 made with a low resistivity doped hybrid organic-inorganic material described herein. The bottom cladding may also include another cladding layer 904. For example, the additional cladding layer 904 may include a relatively high resistivity material such as a UV-cured polymer, a cross-linked polymer, or another conventional cladding material. The upper cladding layer 106 may be formed from a low resistivity doped hybrid organic-inorganic material as described above.

One attribute of the device structure 901 may be that the etching process used to form the waveguide structure 114 may be performed on an alternative material. Etching an alternative material may be advantageous in some embodiments for process considerations.

A push-pull Mach-Zehnder electro-optic modulator was fabricated using the device structure 901. The best poling voltage to obtain lowest Vπ for the device structure 901 was found to be about 500 volts. Varying the thickness of the upper cladding layer 106, made from a doped hybrid organic-inorganic cladding, was found not to affect either the optimum poling voltage or the operating voltage. This showed another advantage of the doped hybrid organic-inorganic cladding, wherein the cladding thickness may be varied considerably. Such an approach may allow relatively thick clads, which may aid in improving light guidance and reducing optical loss. For example, an embodiment includes a top clad thickness of 1.5 microns thickness or greater, compared to a more conventional 0.4 to 1.4 microns thickness. According to an embodiment, the top clad thickness may be about 2 microns thickness. According to another embodiment, the top clad may be about 2.8 microns thickness or greater.

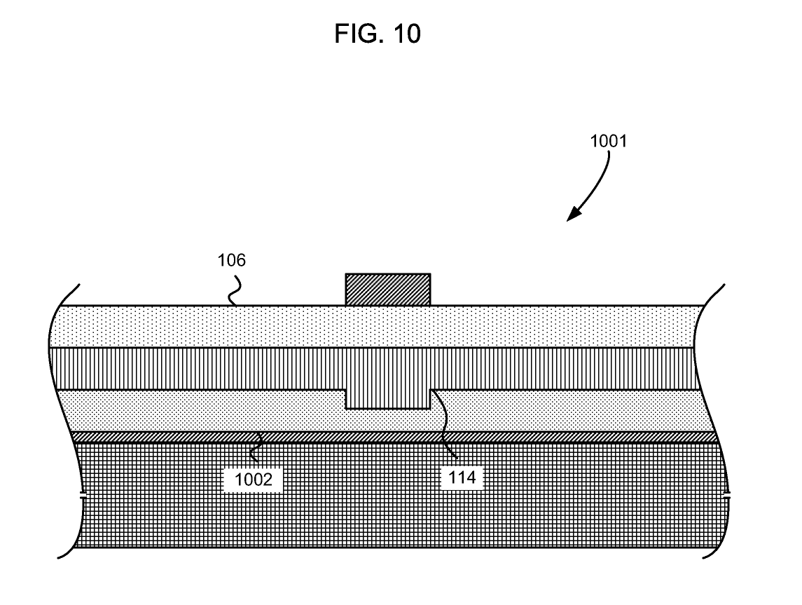

FIG. 10 is a cross-sectional diagram of another alternative device structure 1001, according to an embodiment. In the embodiment of FIG. 10, the bottom hybrid organic-inorganic doped cladding layer 104 is substituted with another type of cladding 1002. The device 1001 uses a bottom clad 1002 with dry-etched trench waveguide 114 formed from UV15LV, a conventional ultraviolet-cured cross-linked polymer. The top-cladding 106 is formed from a low resistivity doped hybrid organic-inorganic material (LP163) taught herein.

For example, the poling efficiency of a device 1001 was higher compared to a conventional electro-optic device made without the doped hybrid organic-inorganic material. The electro-optic coefficient of the device 1001, a Mach-Zehnder modulator operating in push-pull mode, was found to be 80 picometers per volt at 1550 nanometers wavelength, compared to 55 picometers per volt for an equivalent device made using the same UN15LV conventional ultraviolet-cured cross-linked polymer for both the bottom clad and the top clad.

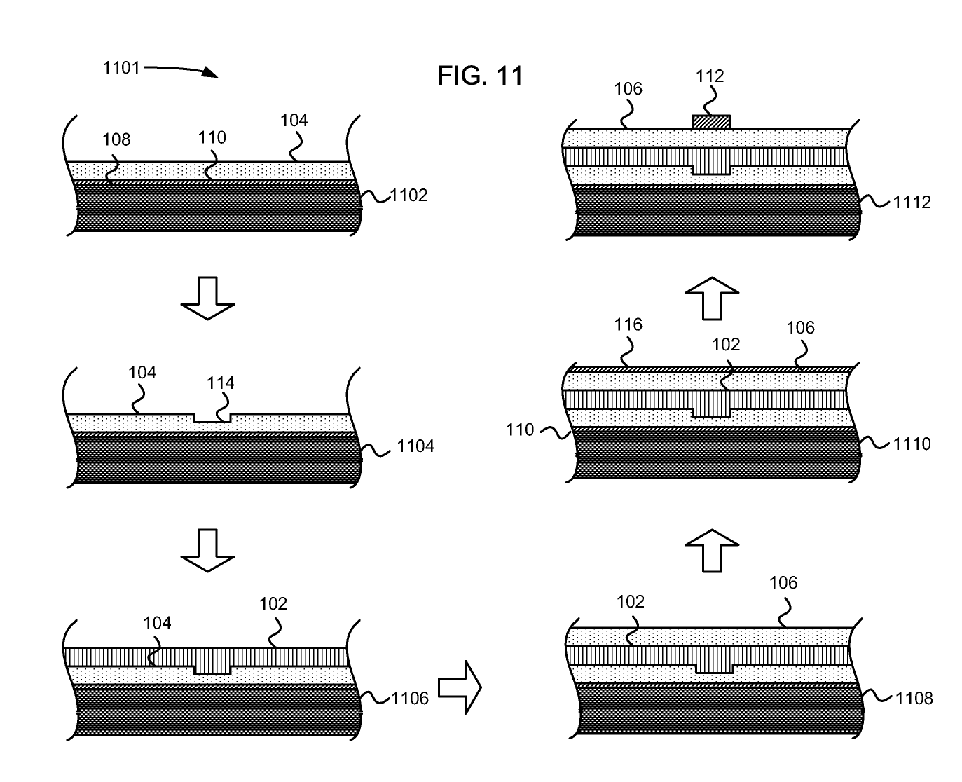

FIG. 11 is a diagram 1101 illustrating a device 101 at several steps of fabrication 1102 to 1112, according to an embodiment. First, as shown at step 1102, a bottom cladding layer 104 is deposited over a substrate 108 and bottom electrode 110. The bottom cladding layer may be a monolithic doped hybrid organic-inorganic material as described elsewhere herein. Alternatively, a bottom cladding layer may be formed as a composite with a first cladding layer 902 made with a low resistivity inorganic salt doped hybrid organic-inorganic material described herein and another cladding layer 904. For example, the additional cladding layer 904 may include a relatively high resistivity material such as a UV-cured polymer, a cross-linked polymer, or another conventional cladding material.

The bottom cladding layer 104 may be deposited as a doped sol-gel solution, as described above. For example, the bottom cladding layer may be deposited by spraying or spin-coating. Then, the bottom cladding may be dried and cured to form a solid film. For example, the wafer may be kept at about 100° C. to 200° C. for a period of time sufficient to provide the desired mechanical properties. For example, the temperature may be maintained for between 30 minutes and 10 hours. There has not been any detrimental effect found arising from 10 hours or longer dry and cure times.

In step 1104, a waveguide structure 114 may be formed in the bottom clad 104. Generally, the waveguide structure 114 is formed parallel and below a top electrode. Etching may be performed by a number of methods. For example, plasma etching such as reactive ion etching or deep reactive ion etching may be used to form a trench waveguide 114, and may be advantageous for forming smooth and vertical trench sides.

Proceeding to step 1106, a core material 102 including hyperpolarizable (aka non-linear) chromophores is deposited over the bottom cladding 104, for example by spin-coating or spraying. If the core material includes a polymer material such as an amorphous polycarbonate, the core 102 may be applied from solution during spinning or spraying, and then baked at elevated temperature to remove the solvent. Optionally, the core material may be reheated to reflow the top surface of the core 102 flat. If the core material includes a hybrid organic-inorganic material such as those described herein, the core may be dried and cured similar to the method described in conjunction with step 1104 above. Generally, it is preferable not to dope a hybrid material for reduced resistivity when it is used as a material for the core 102.

Proceeding to step 1108, a top cladding 106 is applied over the electro-optic material layer 102. Preparation, application, drying, and curing of the doped hybrid organic-inorganic material may be done as described above. Alternatively, the top cladding 106 may include another material such as a UV-cured polymer, UV-cured fluorinated sol-gel materials, a cross-linked polymer, a non-fluorinated sol-gel, or another conventional cladding material.

Proceeding to step 1110, a poling electrode 116 may be formed over the upper cladding layer 106, and the electro-optic core 102 poled to align the chromophores as described above. The top electrode 112/116 shown in FIG. 1 may be configured as a modulation electrode and/or as a poling electrode. In some embodiments, such as that illustrated by FIG. 11, the poling electrode 116 may be removed after poling and a high speed electrode formed.

During step 1110, the poling electrode 116 may be formed, for example by sputtering or solution plating over the top cladding 106. During poling, the core material 102 is brought up to near its glass transition temperature. Generally, it may be preferable for the temperature to be within ±10° C. of the glass transition temperature of the cross-linking core polymer. The elevated temperature makes it easier for the polar chromophore molecules to rotate to a parallel orientation responsive to the applied poling voltage.

Then, a poling circuit applies a poling voltage to the poling electrode and maintains the bottom electrode 110 at ground. The poling voltage may be a relatively low poling voltage of about 500 volts or may be up to about 900 to 1000 volts, depending on the device configuration. Typically, the poling voltage is maintained for about one to three minutes while the temperature is maintained, then the temperature is allowed to drop. The poling voltage is removed, typically shortly after the temperature reaches room temperature. The reduction in temperature causes the core polymer to drop below its glass transition temperature, which tends to immobilize the chromophores in the poled orientation.

As described above, the doped hybrid organic-inorganic cladding materials described herein undergo a significant reduction in resistivity at elevated temperatures corresponding to the poling temperature. As described above, this allows more efficient application of poling voltage to the core 102 than was previously available.

According to alternative embodiments, the modulation electrode 112 may be used as a poling electrode 116. This is more feasible using the materials described herein because of the high efficiency of poling. However, the process 1101 shows a more conventional approach where separate poling 116 and modulation 112 electrodes are used.

Proceeding to step 1112, the poling electrode 116 is stripped off the top of the top cladding 106. Optionally, an additional thickness of top cladding material may be deposited over the stripped top cladding 106. Then, a modulation electrode 112 is formed. The modulation electrode 112 is typically configured as a high speed (aka RF) strip electrode configured to conduct modulation signals at very high modulation bandwidths corresponding to optical signal transmission bandwidths. Typically, trace and electrode layouts take propagation delay and signal termination into account to maximize the transmission of in-phase, clean signals while minimizing reflections, impedence, and other deleterious effects.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for making a hybrid optical cladding, comprising:
mixing a sol-gel solution and salt dopant;
gelling the mixture to produce a hybrid polymer with inorganic salt dopant; and
drying and curing the gel to form a film.

2. The method of claim 1, wherein the sol-gel includes a silicon, titanium, aluminum, or zirconium atom.

3. The method of claim 2, wherein the sol-gel includes a silicon or titanium atom.

4. The method of claim 1, wherein the sol-gel includes at least one selected from the group consisting of: 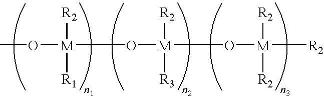
R₁=-alkyl or aromatic groups
R₂═H, alkoxy groups, —O—CH₃, —O—(CH₂)ₙCH₃
R₃=crosslinkable groups 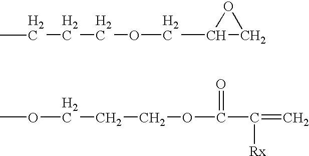
M=Si, Ti, Al, Zr

5. The method of claim 4, wherein the sol-gel includes:

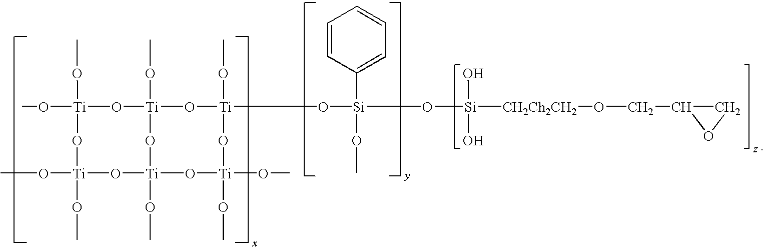

6. The method of claim 5, wherein y is greater than x.

7. The method of claim 1, wherein the salt dopant is present at a weight percentage of about 2% or less; and
wherein the hybrid optical cladding film undergoes a reduction in electrical resistivity at a poling temperature.

8. The method of claim 7, wherein the resistance of the hybrid optical cladding film is about 10⁷ ohms⁻¹ cm⁻¹ or less at about 140° C.

9. The method of claim 7, wherein the resistance of the hybrid optical cladding film is about 10⁹ ohms⁻¹ cm⁻¹ or less at about 20° C.

10. The method of claim 1, wherein the salt dopant includes a salt of lithium, sodium, or potassium.

11. The method of claim 10, wherein the salt dopant includes lithium perchlorate.

12. The method of claim 10, wherein the inorganic dopant is molecularly dispersed in the sol-gel after drying and curing.

13. The method of claim 1, wherein the hybrid optical cladding is substantially non-hygroscopic.

14. The method of claim 1, wherein the hybrid optical cladding film has an optical loss of less than about 2 dB per centimeter.

15. The method of claim 1, wherein the hybrid optical cladding film is substantially non-scattering to light at about 1550 nanometers.

16. The method of claim 1, further comprising:
etching the hybrid optical cladding film to form at least one waveguide structure.

17. The method of claim 1, wherein the mixture is disposed on at least one selected from the group consisting of a substrate, an electrode, or an electro-optic layer prior to gelling.

18. The method of claim 1, further comprising forming a second optical cladding layer over or under the hybrid optical cladding, the second optical cladding layer including at least one selected from the group consisting of a thermoplastic polymer, an organic polymer, and a UV-curable polymer.

19. A method of making an electro-optic device, comprising:
forming at least one hybrid optical film doped with an inorganic salt,
forming at least one polymeric nonlinear optical film over or under the hybrid optical film; and
poling the at least one polymeric nonlinear optical film through the at least one hybrid optical film doped with an inorganic salt.

20. The method of claim 19, wherein at least one layer of hybrid optical film doped with an organic salt and at least one layer of polymeric nonlinear optical film are formed adjacent to one another.

21. The method of claim 19, wherein poling includes raising the temperature of the at least one polymeric nonlinear optical film and hybrid optical film to near a glass transition temperature of the films, and applying an electrical field of about 500V.

22. The method of claim 21, wherein the poling field is maintained for about a minute.

23. The method of claim 19, wherein at least one layer of the hybrid optical film is etched prior to at least one layer of the polymeric nonlinear optical film being deposited thereon.

24. An electro-optic device, comprising:
an electro-optic core and an optical cladding;
wherein the electrical resistivity of the optical cladding is at least about an order of magnitude lower than the resistivity of the electro-optic core at a poling temperature.

25. The electro-optic device of claim 24, wherein the electrical resistivity of the optical cladding is at least about two orders of magnitude lower than the resistivity of the electro-optic core.

26. The electro-optic device of claim 24, wherein the electro-optic core includes at least one hyperpolarizable organic chromophore and a cross-linked polymer.

27. The electro-optic device of claim 26, wherein the at least one hyperpolarizable organic chromophore and the polymer form a guest-host material.

28. The electro-optic device of claim 24, wherein the optical cladding includes a hybrid organic-inorganic material.

29. The electro-optic device of claim 28, wherein the optical cladding further includes an inorganic salt of lithium, sodium, or potassium at a concentration equal to or less than about 5%.

30. The electro-optic device of claim 29, wherein the optical cladding further includes an inorganic salt of lithium, sodium, or potassium at a concentration equal to or less than about 2%.

31. The electro-optic device of claim 30, wherein the optical cladding further includes lithium perchlorate at a concentration equal to or less than about 2%.

32. The electro-optic device of claim 31, wherein the optical cladding further includes an inorganic salt of lithium, sodium, or potassium at a concentration equal to or less than about 5%.

33. The electro-optic device of claim 32, wherein the optical cladding further includes an inorganic salt of lithium, sodium, or potassium at a concentration equal to or less than about 2%.

34. The electro-optic device of claim 33, wherein the optical cladding further includes lithium perchlorate at a concentration equal to or less than about 2%.

35. The electro-optic device of claim 24, wherein the optical cladding includes a sol-gel.

36. The electro-optic device of claim 35, wherein the optical cladding further includes an inorganic salt of lithium, sodium, or potassium at a concentration equal to or less than about 5%.

37. The electro-optic device of claim 36, wherein the optical cladding further includes an inorganic salt of lithium, sodium, or potassium at a concentration equal to or less than about 2%.

38. The electro-optic device of claim 37, wherein the optical cladding further includes lithium perchlorate at a concentration equal to or less than about 2%.

39. The electro-optic device of claim 24, wherein the electro-optic core and optical cladding includes a bottom clad and a top clad, the bottom and top clads formed from a sol-gel doped with an inorganic salt at a concentration of about 1% to 3%, and wherein the electro-optic core is disposed between the bottom and top clads.

40. The electro-optic device of claim 39, further comprising at least one organic polymer clad disposed over or under at least one of the bottom or top hybrid clads.

41. The electro-optic device of claim 39, further comprising:
a substrate;
a bottom electrode disposed on the substrate;
wherein the bottom clad, electro-optic core, and top clad are disposed over the bottom electrode; and
a top electrode disposed over the top clad.

42. The electro-optic device of claim 41, further comprising a waveguide structure disposed parallel to the top electrode.

43. The electro-optic device of claim 41, wherein at least one of the top and bottom electrodes is configured as a high speed strip electrode.

44. The electro-optic device of claim 41, wherein the top and bottom electrodes are configured to provide an electrical drive pulse of about 0.9 to 1.1 volts through the bottom clad, electro-optic core, and top clad.

45. The electro-optic device of claim 44, wherein the bottom clad, electro-optic core, and top clad are configured to deliver more than about 50% of the drive voltage across the electro-optic core.

46. The electro-optic device of claim 45, wherein the bottom clad, electro-optic core, and top clad are configured to deliver more than about 90% of the drive voltage across the electro-optic core.

47. The electro-optic device of claim 41, wherein the top electrode is configured as a poling electrode.

48. The electro-optic device of claim 47, further comprising:
a poling circuit configured to apply a poling voltage to the poling electrode and the bottom electrode.

49. The electro-optic device of claim 48, wherein the poling circuit includes a voltage source configured to provide the poling voltage, the poling voltage being about 500 V.

50. The electro-optic device of claim 49, wherein:
the bottom clad is about 1-2.0 microns thick;
the electro-optic core is about 3 microns thick at a trench waveguide; and
the top clad is about 0.5 to 2.0 microns thick.

51. The electro-optic device of claim 49 wherein:
the bottom clad is about 2-2.4 microns thick;
the electro-optic core is about 3 microns thick; and
the top clad is about 0.5 to 2.0 microns thick.

52. An optical cladding, comprising:
a hybrid organic-inorganic material; and
an inorganic salt of lithium, sodium, or potassium at a concentration equal to or less than about 5%.

53. The optical cladding of claim 52, wherein inorganic salt of lithium, sodium, or potassium is at a concentration equal to or less than about 2%.

54. The optical cladding of claim 53, wherein inorganic salt of lithium, sodium, or potassium includes lithium perchlorate.

55. The optical cladding of claim 52, wherein the hybrid organic-inorganic material includes a sol-gel.

56. The optical cladding of claim 52, wherein the hybrid organic-inorganic material and the inorganic salt are in solution.

57. The optical cladding of claim 52, wherein the hybrid organic-inorganic material is in a film and the inorganic salt is molecularly dispersed in the film.

58. The optical cladding of claim 52,
wherein the hybrid organic-inorganic material includes: 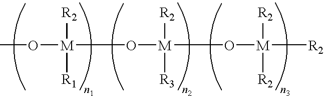
R₁=-alkyl or aromatic groups
R₂═H, alkoxy groups, —O—CH₃, —O—(CH₂)ₙCH₃
R₃=crosslinkable groups 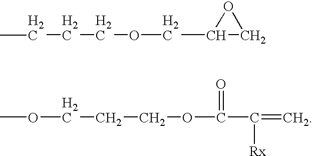
M=Si, Ti, Al, Zr

59. The optical cladding of claim 58,
wherein the a hybrid organic-inorganic material includes: [chemical structure]
